(19) United States
(12) Patent Application Publication
(10) Pub. No.: US 2026/0326423 A1
(43) Pub. Date: Oct. 22, 2026

(54) COMPOSITE BAG MATERIAL PRODUCED FROM RECYCLED MATERIAL

(71) Applicant: NETPAK AMBALAJ SANAYI TICARET ANONIM SIRKETI, Istanbul (TR)

(72) Inventor: Ali AVCI, Istanbul (TR)

(21) Appl. No.: 19/474,764

(22) PCT Filed: Apr. 16, 2021
(86) PCT No.: PCT/TR2021/050357

§ 371 Date: Oct. 13, 2025

(51) Int. Cl. B32B 27/12; B32B 1/00; B32B 5/02; B32B 27/32; B65D 65/40

(52) U.S. Cl. CPC B32B 27/12; B32B 1/00; B32B 5/022; B32B 27/32; B65D 65/40; B32B 2250/03; B32B 2262/0253; B32B 2305/70; B32B 2307/514; B32B 2439/06; B65D 2565/384

(57) ABSTRACT

Provided is a composite carrier bag material consisting of a multilayered structure, having many advantages such as being economic, ecological, and 100% recyclable in accordance with the zero-waste logic, where the composite carrier bag material is manufactured by using a reduced level of original raw material thanks to the use of up to 100% recycled (scrap) material, and has an increased strength, durability and carrying capacity.

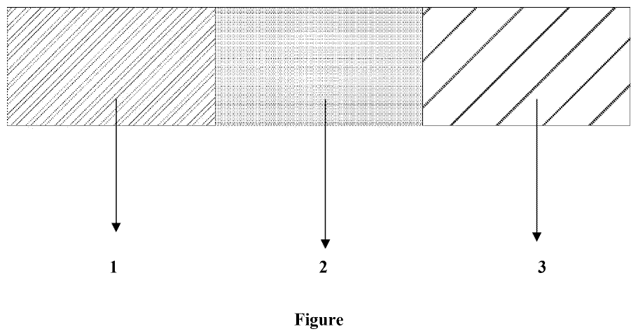

### CROSS REFERENCE TO THE RELATED APPLICATIONS

This application is the national phase entry of International Application No. PCT/TR2021/050357, filed on Apr. 16, 2021, the entire contents of which are incorporated herein by reference.

### TECHNICAL FIELD

The invention relates to a composite carrier bag material consisting of a multilayered structure and having many advantages such as being economic, ecological, and 100% recyclable in accordance with the zero-waste logic, wherein the composite carrier bag material is manufactured by using a reduced level of original raw material thanks to the use of up to 100% recycled (scrap) material and has an increased strength, durability and carrying capacity.

### BACKGROUND

As is known, original plastic raw material production is considerably limited in our country and the plastic industry fulfills its need in this regard, to a great extent, by way of importing, thereby leading to an increase in our current account deficit. Therefore, the said industry becomes exposed to external shocks such as fluctuations experienced in the exchange rate and events of force majeure (supply crisis that is attributed to an event of force majeure by petrochemical companies within the scope of international trade and that bears legal consequences). The recycling industry acts as an anchor that ensures supply security in the plastics industry by converting the scraps sourced both domestically and internationally into raw materials. Our natural resources are depleting day by day due to the increase in the world population and the change in consumption habits. For this reason, natural resources should be utilized efficiently by way of reducing consumption of materials and recycling reusable waste. Glass, metal, plastic, and paper/cardboard packaging is obtained using our natural resources such as forests, water, oil, etc. in the production process. Packages released to the market can be used as secondary/tertiary raw material in the production phase of various goods after such packages are channeled to the recycling industry by being separated based on their types when they are no longer a package but a waste. Thus, we use less of our natural resources and contribute to nature. Employing used packages and similar reusable waste as a source of raw material allows and enables us to protect and save the raw material or natural resource that would otherwise be used up for the material it has been substituted for, and this ensures a significant saving.

Having been used as packaging material for the last 50 years, plastics have invaded all over the world. Together with the idea of creating a solution, the fact that plastics take too long to decompose in nature, making it one of the serious dangers in terms of environmental pollution, and that the world plastic consumption is gradually increasing has brought forward the issue of recycling of these materials. The recycling industry is one of the most important pillars of zero-waste policies across the world. This is due to the fact that reducing carbon emissions is one of the main goals. Economic value is created by recycling instead of burial or incineration. in addition, the energy consumed over the course of plastic recycling is one-eighth more efficient than the energy used in the production of original raw materials. in other words, it has superior features in terms of energy efficiency. Nonetheless, capacity development is essential to further enhance and expand the zero-waste movement initiated in our country and the world. Strengthening the recycling industry will contribute to faster and more efficient recovery of the waste available.

The recycling industry is employment-friendly. Analyses show that for every 1 person employed in solid waste storage and incineration, 20 people are employed in the recycling industry. The importance of the concerned industry is even higher in countries such as Turkey where a rapidly growing young population lives and unemployment constitutes a structural problem. it creates job opportunities for 1 million people considering the industry itself and the sectors it provides supplies to. 350,000 of these individuals are employed directly in the plastics industry.

In 2018, approximately 8.5% of the plastics produced in the USA were separated and recycled. Plastic packaging and containers, on the other hand, were recycled by 13.1%. 30 percent of all plastic waste in the world is recycled in Europe. In the United States, 3 million tons of plastic products were recycled in 2017 and 3.02 million tons in 2018. According to research, 50% of plastic products used in daily life go to waste after the first use. Plastics accounted for 12% of the total global waste generation in 2016. It can take centuries fora plastic left to nature to decompose. Plastic waste thrown into the oceans is broken down into small pieces and causes the death of 100,000 marine mammals and 1,000,000 seabirds each year. Through the fish they consume, humans swallow the small plastic pieces that fish eat thinking it is food.

Nowadays, people are accustomed to using disposable plastic film bags while shopping in places such as supermarkets, open markets, etc.; however, as the world environment deteriorates and people's environmental awareness gradually increases, the harms of single-use plastic film bags for the environment have become more evident. Due to this pollution, countries tried to ban and restrict the use of disposable plastic film bags for shopping. The adoption of reusable bags or shopping bags made of environmentally-friendly materials has recently become popular. There are various bags used for this purpose. Paper bags are one of them. However, the biggest disadvantages of paper bags are having low strength, being disposable, requiring high costs for production, so they are not attractive.

The invention in the document numbered “CN210654344U” is a utility model, and the document discloses a composite bag consisting of a tensile environmentally-friendly paper-plastic. The paper-plastic composite bag is made of plastic and craft paper. in the paper-plastic composite bag, the base material is manufactured by using a plastic woven bag through the method of molding. Polypropylene or polyethylene is preferably used for the plastic layer. Sealing seam lines are arranged at the two ends of the composite bag body. Carrying buckle holes are placed at the two end edges of the composite bag body. Carrying buckle holes are arranged at the outer edges.

The application above does not employ recycled material in the production of the disclosed bags. Moreover, when the concerned product expires, it cannot be recycled since it is made up of a combination of paper and plastic. This, in turn, leads to high production costs and the accumulation of more plastic in nature. While it is claimed to be environmentally friendly since it is made of paper, it is in fact rather harmful to the environment because paper mills cause high levels of air pollution, consume too much resource, have an impact on global warming, and also the paper is not practical to be reused. The invention in the document numbered “CN104340483A” discloses a composite paper bag. The invention includes a paper bag bottom and a paper bag body connected to the paper bag bottom and extending to both sides; the paper bag is formed by a grid-like skeleton and composite paper and includes a latticed skeleton. The above-mentioned disadvantages apply to this application as well.

In conclusion, the requirement for the elimination of shortcomings and disadvantages of embodiments and practices existing in the prior art and already being used as of today entails an improvement in the respective technical field.

### SUMMARY

The present invention relates to a multi-layered composite bag material developed for eliminating the aforementioned disadvantages and providing new advantages to the respective technical field.

The main objective of the present disclosure is to manufacture environmentally-friendly products being made by using a reduced level of original raw material thanks to the use of waste plastics, having an increased strength, durability and carrying capacity, being economic and 100% recyclable in accordance with the zero-waste logic.

Another objective of the present disclosure is to create a bag material being reusable, economic and recyclable by reducing the need for main raw material through the utilization of scrap products.

A further objective of the present disclosure is to create a composite bag material being environmentally conscious by reducing the need for waste disposal in general, thereby decreasing water pollution, air pollution (regular storage), and greenhouse gas emissions.

Another objective of the present disclosure is to create a bag material with increased strength and durability, wherein the said bag material takes up less space and is lighter compared to a bag material with the same level of durability.

When the present invention (total weight 60 gr) is compared to a single layer nonwoven product with the same weight (60 gr), such nonwoven product presents disadvantages such as splitting on the weak side, tearing, and not being able to provide the required durability since it consists a single layer. Thanks to the three-layered structure in our composite material, rather weak and split-inclined parts and normal parts are positioned on each other, and required sealing is ensured by extruding 100% recycled material in between the said two parts to glue them together, thereby creating a composite material that is powerful and has high strength and durability in comparison to the nonwoven product of the same weight (60 gr).

Another objective of the present disclosure is to ensure, with our three-layered composite structure of 60 gr, the strength provided by a single-layer nonwoven material of 80 gr. Thus, the same strength and durability are presented with a lighter material structure. Being lightweight provides a significant advantage in especially bag materials.

A further objective of the present disclosure is to reduce the amount of waste sent to regular storage areas by turning old and waste products into new ones because recycled products protect natural resources and save energy required to produce original plastic, and 7.4 cubic meters of landfill can be saved by recycling one ton of plastic. Our current application contributes to this objective since scrap material is used at a ratio of approximately ⅓.

Another objective of the present disclosure is to save energy by decreasing the number of industrial procedures in material production that is necessary over the course of using recycled material. Producing materials through recycling ensures a significant energy saving since the number of physical and chemical procedures during recycling is lower compared to usual production procedures. Moreover, water-saving at a rate of 45% is provided. Manufacturing materials from plastic waste in this way ensures considerable energy saving. A further objective of the present disclosure is to provide an economic investment that is efficient in the long term by using recycled material. The decrease in raw materials and rapid depletion of natural resources can lead to economic problems. Recycling has positive effects on the economy in this regard. Reducing the consumption of energy and natural resources is also of great importance for the country's economy. in addition, as a result of the decrease in the consumption of raw materials such as oil far which we are dependent on foreign countries, our money remains within the borders of our country and our economy gets better and our current account deficit decreases.

Exporting our products such as synthetic fiber, which are produced as a result of recycling, provides foreign currency inflow to our country. Furthermore, using the natural resources that the world we live in has provided us efficiently, thanks to the concerned invention, is important to ensure that future generations do not experience resource shortages. The more economically we use the natural resources of this world, the fewer resource shortages next generations will experience, and therefore the next generations will also have the opportunity to benefit from natural resources. On the other hand, the recycling industry in our country is developing day by day. This development will enable the establishment of new facilities and the creation of new job and business opportunities.

### BRIEF DESCRIPTION OF THE DRAWINGS

The embodiments of the present invention, briefly summarized above and discussed in more detail below, can be understood by referring to the exemplary embodiments of the invention described in the accompanying drawings. However, it should be noted that the accompanying drawings illustrate only the typical embodiments of the present invention and therefore is not deemed to limit its scope as it may allow other equally effective applications.

For the sake of clarity, identical reference numbers are used wherever possible, to indicate identical elements common to the figures. The figures are not drawn to scale and can be simplified for clarity. it is contemplated that the elements and features of an application can be usefully incorporated into other applications without the need for further explanation.

Figure: This is the general view of layers of a preferred embodiment of the invention.

### EXPLANATION OF THE DETAILS IN THE DRAWINGS

Explanations of reference numbers shown in the drawings are given below.
1—OPP Film (Oriented PP)
2—Up to 100% Recycled PP Material
3—PP Nonwoven

### DETAILED DESCRIPTION OF THE EMBODIMENTS

The preferred alternatives of the embodiment of the present disclosure, which are mentioned in this detailed description, are only intended for providing a better understanding of the subject matter, and should not be construed in any restrictive sense.

The invention consists of printed or plain OPP Film (Oriented PP) (1) in the 1^{st} layer, a 100% recycled and extruded PP Material (2) in the 2^{nd} layer, and a PP Nonwoven (3), which is a nonwoven technical fabric, in the 3^{rd} layer. Here, thanks to the PP (2) material, which is recycled and extruded up to 100%, it is ensured that all layers adhere to each other.

OPP is a product that is manufactured by aiming to change the mechanical properties of polypropylene by stretching it in one direction during its production in film form. OPP material is an example of plastic materials that are flexible, protective against chemicals and the most harmless in terms of health. Nonwoven materials are textile surfaces obtained by fixing the web created through bonding of fibers by use of different methods, except for classical methods such as weaving and knitting, by mechanical, chemical, and thermal means, i.e., by interlocking and bonding the said web. Nonwovens are employed in the textile industry. While the raw material used in the manufacturing of the nonwoven material described in this invention can be fully original, it is also possible to add recycled granular material at a certain rate. Similarly, OPP Film Layer (1) and Mesh Layer, etc. produced by using a certain amount of recycled granular material can be utilized in other layers to be formed.

Considering the bonding of the layers of the invention together, up to 100% recycled and extruded PP Material (2) is employed as adhesive if the main material in the layers is PP while PE Material is used if the main material in the layers is PE. Bonding by using the same material provides convenience in terms of recycling the material as explained above. Although PP (polypropylene) is the preferred embodiment as the material in the figure in the invention, PE (polyethylene) can also be utilized as explained above. What is important here is that all plastics suitable for recycling, ultrasonic welding and garment sewing can be employed. However, in order for the material to go to recycling properly, the layers created must be uniform, i.e., in the form of PP-PP-PP material or in the form of PE-PE-PE. in short, all layers must be of the same type of plastic. When all layers are made of the same material, the product can be easily recycled after it has completed its lifetime. So, it becomes a product that can be recycled up to 100%. The material produced in this way no longer damages nature and it contributes to the economic cycle and nature positively.

In the present invention, two types of polyethylene, i.e., low-and high-density polyethylene, can both be used. in another alternative embodiment of the invention, the composite material can also be formed by the combination of HDPE (High-Density Polyethylene) film in the 1^{st} layer, up to 100% recycled (scrap) HDPE (High-Density Polyethylene) in the 2^{nd} layer, and HDPE (High-Density Polyethylene) film in the 3^{rd} layer. In this regard, choosing low-density or high-density polyethylene does not interfere with the objective of the invention in terms of recycling. Therefore, in another embodiment, the composite material can also be formed by combining LDPE (Low-Density Polyethylene) film in the 1^{st} layer, up to 100% recycled (scrap) LDPE (Low-Density Polyethylene) in the 2^{nd} layer, and LDPE (Low-Density Polyethylene) film in the 3^{rd} layer. While the invention can be 3-layered as in the preferred embodiment in the figure, an alternative embodiment of the invention can also have more than 3 layers in order to increase its strength even more. in the preferred 4-layered embodiment of the invention, composite structure with increased strength is formed thanks to the OPP Film (1) in the 1^{st} layer, up to 100% recycled and extruded PP Material (2) in the 2^{nd} layer, a PP Net in the 3^{rd} layer, and the PP Nonwoven (3) in the 4^{th} layer. The net layer (polypropylene) here provides power and strength to the general structure of the material because of its tightly woven structure of knitted filaments. Therefore, a structure with increased strength is created.

In another alternative embodiment that does not interfere with the objective of the invention but rather enables the invention's use in other areas, the product consists of the nonwoven material in the 1^{st} layer, up to 100% recycled and extruded material (2) in between, and nonwoven material again in the 3^{rd} layer. Here, pouring up to 100% recycled material between the two nonwoven materials ensures sealing the material layers to each other tightly and solidly. Moreover, the poured material in between makes the product impermeable (waterproof). The embodiment provided accordingly can be used for purposes such as a sunbed cover, mattress pad, packaging for wrapping, etc.

In another alternative embodiment, the invention may consist of a paper in the 1 st layer, up to 100% recycled (scrap) PP (2) in the 2^{nd} layer, and the PP Nonwoven (3) in the 3^{rd} layer.

What is claimed is:

1. A composite carrier bag material consisting of a multilayered structure, wherein the multilayered structure comprises a printed or plain oriented polypropylene (OPP) film in a first layer, an up to 100% recycled (scrap) and extruded polypropylene (PP) material in a second layer, and a PP nonwoven in a third layer; wherein the up to 100% recycled (scrap) and extruded PP material ensures sealing of all layers, and the PP nonwoven is a nonwoven technical fabric.

2-5. (canceled)

6. The composite carrier bag material according to claim 1, wherein a PP Net layer is additionally provided between the second layer and the third layer.

7-8. (canceled)
